(19) United States
(12) Patent Application Publication
(10) Pub. No.: US 2002/0123581 A1
(43) Pub. Date: Sep. 5, 2002

(54) Process for the preparation of EP(D)M

(76) Inventors: Peter Schertl, Leverkusen (DE); Wolfgang Nentwig, Bergisch Gladbach (DE); Rudiger Engehausen, Dormagen (DE); Walter Kaminsky, Pinneberg (DE); Ulrich Weingarten, Hamburg (DE)

Correspondence Address: BAYER CORPORATION, PATENT DEPARTMENT, 100 BAYER ROAD, PITTSBURGH, PA, 15205, US

(21) Appl. No.: 09/904,964

(22) Filed: Jul. 13, 2001

(30) Foreign Application Priority Data
Jul. 17, 2000 (DE) 100355091.7

(51) Int. Cl. C08F 4/44

(52) U.S. Cl. 526/127; 526/160; 526/943; 526/283; 526/282; 526/335; 526/348.2; 526/348.5; 526/348.6

(57) ABSTRACT

The present invention relates to a process for the preparation of rubber-like ethylene/α-olefin copolymers and ethylene/α-olefin/non-conjugate diene terpolymers using a metallocene as catalyst, which process is characterized in that the metallocene used is a compound of the general formula (I)

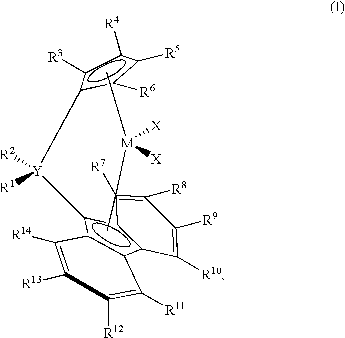

wherein

R¹ to R¹⁴ are each independently of the others H, saturated and unsaturated C₁-C₁₂-alkyl radicals, C₆-C₁₂-aryl radicals or saturated and unsaturated C₇-C₁₂-aralkyl radicals,

X represents H, halogen, C₁-C₁₂-alkyl radicals,

Y represents Si or Ge,

M represents a metal of group 4 of the periodic system of the elements according to IUPAC 1985,

optionally in the presence of one or more co-catalysts, and to the use of the polymers so obtainable in the production of moulded bodies of any kind.

The present invention relates to a process for the preparation of rubber-like ethylene/α-olefin copolymers and ethylene/α-olefin/non-conjugate diene terpolymers using a metallocene as catalyst, characterised in that the metallocene used is a compound of the general formula (I)

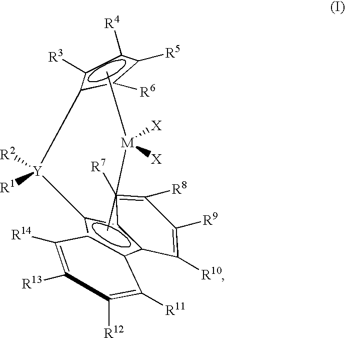

wherein

R¹ to R¹⁴ are each independently of the others H, saturated and unsaturated C₁-C₁₂-alkyl radicals, C₆-C₁₂-aryl radicals or saturated and unsaturated C₇-C₁₂-aralkyl radicals,

X represents H, halogen, C₁-C₁₂-alkyl radicals,

Y represents Si or Ge,

M represents a metal of group 4 of the periodic system of the elements according to IUPAC 1985,

optionally in the presence of one or more co-catalysts,

and to the use of the polymers so obtainable in the production of moulded bodies of any kind.

Owing to their saturated main chain, ethylene/propylene copolymers (EPM) and ethylene/propylene/non-conjugate diene terpolymers (EPDM) are important substances for use in industry. In order to acquire their final properties, the polymers must be crosslinked by means of peroxides, radiation or sulfur/sulfur agents. In the case of sulfur crosslinking in particular, the content of unsaturated bonds in the EPDM is important, which is adjusted by the content of non-conjugate diene. A high molecular weight is of essential importance for the in-use properties as a rubber. Many catalysts have been developed for tailoring the composition, molecular weight and microstructure of EPM and EPDM.

It is state of the art to prepare EPM and EPDM using catalysts based on Ziegler-Natta systems. Vanadium-containing catalysts are mostly used therefor. The processes are carried out in solution, suspension or in the gas phase.

It is state of the art to prepare ethylene/propylene copolymers using biscyclopenta-dienylzirconium compounds (EP-A1-0 129 368), but the rate of incorporation of the non-conjugate diene is mostly unsatisfactory or the molecular weight is not sufficient with a simultaneously high degree of activity of the catalyst used.

U.S. Pat. No. 4,892,851 discloses a compound in which a cyclopentadienyl ligand (cp) is linked to a fluorenyl ligand (flu) by way of a dimethylmethylene bridge. No disclosure is made regarding the possibility of its use in conjunction with a non-conjugate diene.

EP-A2-0 512 554 likewise discloses bridged cp-flu compounds and their use as catalysts for the polymerisation of olefins. No disclosure is made regarding the possibility of their use in conjunction with a non-conjugate diene.

U.S. Pat. No. 5,158,920 discloses bridged cp-flu compounds and their use in the preparation of stereospecific polymers. Bridged cp-flu compounds are also known from other documents.

In summary, it can be said that catalysts of that type generally exhibit weaknesses as regards the chain length of the resulting EP(D)M, so that oils or waxes that cannot be used commercially are often obtained. Furthermore, the activities of such catalysts are not sufficient to permit their use in an economical process.

The object of the present invention was to provide a process for the preparation of EPM and EPDM that does not exhibit the disadvantages of the prior art.

That object is achieved according to the invention by a process for the polymerisation of ethylene, α-olefin and, optionally, a non-conjugate diene using a metallocene as catalyst, which process is characterised in that the metallocene used is a compound of the general formula (I)

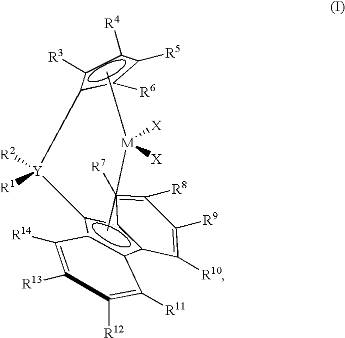

wherein

R¹ to R¹⁴ are each independently of the others H, saturated and unsaturated C₁-C₁₂-alkyl radicals, C₆-C₁₂-aryl radicals or saturated and unsaturated C₇-C₁₂-aralkyl radicals,

X represents H, halogen, C₁-C₁₂-alkyl radicals,

Y represents Si or Ge,

M represents a metal of group 4 of the periodic system of the elements according to IUPAC 1985,

optionally in the presence of one or more co-catalysts.

In view of the prior art, that was surprising.

α-Olefin is to be understood as meaning monounsaturated hydrocarbons that have from 1 to 12 carbon atoms and possess a terminal double bond, such as propylene, 1-butene, 1-pentene, 1-hexene, 1-heptene, 1-octene, 1-nonene, 1-decene, 1-undecene and 1-dodecene. Propylene, 1-butene, 1-hexene and 1-octene are preferred.

C₁-C₁₂-Alkyl is to be understood as meaning all linear or branched alkyl radicals having from 1 to 12 carbon atoms that are known to the person skilled in the art, such as methyl, ethyl, n-propyl, isopropyl, n-butyl, isobutyl, tert-butyl, n-pentyl, isopentyl, neopentyl and hexyl, which may in turn be substituted. Suitable substituents are halogen or alternatively C₁-C₁₂-alkyl or -alkoxy, as well as C₆-C₁₂-cycloalkyl or -aryl, such as benzoyl, trimethylphenyl, ethylphenyl, chloromethyl and chloroethyl.

C₁-C₁₂-Alkoxy is to be understood as meaning all linear or branched alkoxy radicals having from 1 to 12 carbon atoms that are known to the person skilled in the art, such as methoxy, ethoxy, n-propoxy, isopropoxy, n-butoxy, isobutoxy, tert-butoxy, n-pentoxy, isopentoxy, neopentoxy and hexoxy, which may in turn be substituted. Suitable substituents are halogen or alternatively C₁-C₁₂-alkyl or -alkoxy, as well as C₆-C₁₂-cycloalkyl or -aryl.

C₆-C₁₂-Aryl is to be understood as meaning all mono- or poly-nuclear aryl radicals having from 6 to 12 carbon atoms that are known to the person skilled in the art, such as phenyl, naphthyl, which may in turn be substituted. Suitable substituents are halogen, nitro, hydroxyl or alternatively C₁-C₁₂-alkyl or -alkoxy, as well as C₆-C₁₂-cycloalkyl or -aryl, such as bromophenyl, chlorophenyl, toloyl and nitrophenyl.

C₇-C₁₂-Aralkyl is to be understood as meaning a combination of the above alkyls with the above-mentioned aryls.

The radicals R¹ to R¹⁴ preferably represent hydrogen, methyl, ethyl, propyl, tert-butyl, methoxy, ethoxy, cyclohexyl, benzoyl, methoxy, ethoxy, phenyl, naphthyl, chlorophenyl and toloyl.

If the radicals X represent halogen, then the person skilled in the art will understand thereby fluorine, chlorine, bromine or iodine, with chlorine being preferred.

M represents Ti, Zr and Hf, with Zr being preferred.

Special preference is given to the use of the catalyst of formula (II)

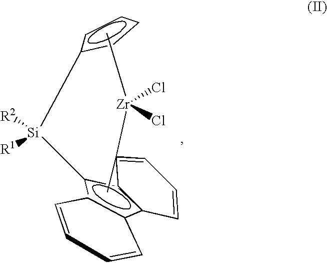

wherein

R¹ and R² are each independently of the other methyl, ethyl, n-propyl, isopropyl, tert-butyl, phenyl or cyclohexyl.

For the polymerisation according to the invention, the compounds of formula (I) or (II) are generally used in combination with co-catalysts. Suitable co-catalysts are the co-catalysts known in the field of metallocenes, such as polymeric or oligomeric alumoxanes, Lewis acids as well as aluminates and borates and other so-called non-coordinating anions. Reference is made in this connection especially to Macromol. Symp. Vol. 97, July 1995, p. 1-246 (for alumoxanes), as well as to EP-A1-0 277 003, EP-A1-0 277 004, Organometallics 1997, 16, 842-857 (non-coordinating anions, especially for borates) and EP-A1-0 573 403 (for aluminates), which for the purposes of U.S. patent practice are incorporated by reference in the Application. There are suitable as co-catalysts especially methylalumoxane, methylalumoxane modified by triisobutylaluminium (TIBA), as well as diisobutylalumoxane, trialkylaluminium compounds, such as trimethylaluminium, triethylaluminium, triisobutylaluminium, triisooctylaluminium, in addition dialkylaluminium compounds, such as diisobutylaluminium hydride, diethylaluminium chloride, substituted triarylboron compounds, such as tris(pentafluorophenyl)borane, as well as ionic compounds containing tetrakis(pentafluorophenyl)borate as anion, such as triphenylmethyl tetrakis(pentafluorophenyl)borate, trimethylammonium tetrakis(pentafluorophenyl)borate, N,N-dimethylanilinium tetrakis(pentafluorophenyl)borate, substituted triarylaluminium compounds, such as tris(pentafluorophenyl)aluminium, as well as ionic compounds containing tetrakis(pentafluorophenyl)aluminate as anion, such as triphenylmethyl tetrakis(pentafluorophenyl)aluminate, N,N-dimethylanilinium tetrakis(pentafluorophenyl)aluminate.

It is, of course, possible to use the catalysts and/or co-catalysts in admixture with one another. The most advantageous mixing ratios in each case are to be determined simply and clearly by means of suitable preliminary tests.

The polymerisation according to the invention is carried out in the gas, liquid or slurry (suspension) phase. The temperature range therefor is from −20° C. to +200° C., preferably from 0° C. to 160° C., especially from +20° C. to +80° C.; the pressure range is from 1 to 50 bar, preferably from 3 to 30 bar. Solvents inert towards the polymerisation that are used are, for example: saturated aliphatic compounds or (halo)aromatic compounds, such as pentane, hexane, heptane, cyclohexane, petroleum ether, petroleum, hydrogenated benzines, benzene, toluene, xylene, ethylbenzene, chlorobenzene and the like. Such reaction conditions for polymerisation are known in principle to the person skilled in the art.

The polymerisation according to the invention is preferably carried out in the presence of inert organic solvents. Examples of inert organic solvents are: aromatic, aliphatic and/or cycloaliphatic hydrocarbons, such as, preferably, benzene, toluene, hexane, pentane, heptane and/or cyclohexane. The polymerisation is preferably conducted as solution polymerisation or in suspension.

In a further preferred embodiment, the process according to the invention is carried out in the gas phase. The polymerisation of olefins in the gas phase was technologically first carried out in 1962 (U.S. Pat. No. 3,023,203). Corresponding fluidised-bed reactors have long been state of the art; reference is made to the document WO-99/19059-A1, which for the purposes of U.S. patent practice is incorporated by reference in the Application.

When used in suspension or in the gas phase, the organometallic compound of formula (I) and (II) and, optionally, the co-catalyst are also applied to an inorganic support and used in heterogeneous form. Suitable inert inorganic solids are especially silica gels, clays, alumosilicates, talcum, zeolites, carbon black, inorganic oxides, such as silicon dioxide, aluminium oxide, magnesium oxide, titanium dioxide, silicon carbide, preferably silica gels, zeolites and carbon black. The mentioned inert inorganic solids may be used individually or in admixture with one another. In a further preferred embodiment, organic supports are used individually or in admixture with one another or with inorganic supports. Examples of organic supports are porous polystyrene, porous polypropylene or porous polyethylene.

Also especially suitable is the process for the preparation of supported polymerisation catalyst systems disclosed in EP-A1-0 965 599 (which for the purposes of U.S. patent practice is at the same time incorporated by reference in the present Application), which process is characterised in that

a) one or more different transition metal complexes are dissolved in a mixture of at least two different solvents that differ in their boiling points,

b) the solution so obtained is brought into contact with one or more different support materials, the volume of the solution being sufficient to form a slurry with the support material(s), the volume of the higher boiling solvent being less than or equal to the total pore volume of the support, and

c) the solvent that boils at the lower temperature is removed to the extent of more than 90%,

wherein, for the preparation of supported catalyst systems according to the invention, either the co-catalyst(s) is/are added together with the transition metal complex(es) in step a) or has/have already been applied to the support material(s) used in step b), or a portion of the co-catalyst(s) is added together with the transition metal complex in step a) and a portion has already been applied to the support material(s) used in step b).

There are suitable as the non-conjugate diene all dienes known to the person skilled in the art whose double bonds have different reactivities towards the catalyst system used, such as 5-ethylidene-2-norbornene (ENB), 5-vinylnorbornene, 1,4-hexadiene and dicyclopentadiene. 5-Ethylidene-2-norbornene and 1,4-hexadiene are preferred.

It may be advantageous to cleanse the materials that are used of impurities, such as oxygen, water or polar substances. In general, the polymerisation is carried out under inert conditions.

The uncrosslinked EPM and EPDM are readily soluble in common solvents, such as hexane, heptane or toluene.

The ethylene content is in the range from 5 to 95 wt. %, preferably from 40 to 90 wt. %.

The propylene content is in the range from 5 to 95 wt. %, preferably from 9.5 to 59.5 wt. %.

The content of non-conjugate diene is in the range from 0 to 20 wt. %, preferably from 0.5 to 12 wt. %.

It goes without saying that the individual monomer contents must add up to 100% and that a person skilled in the art will select them accordingly and expediently from the individual wt. % ranges.

It is a particular advantage of the process according to the invention that the catalyst can remain in the end product and does not interfere with further processing or with use.

For applications in the low-temperature range it may be advantageous to use products having a crystallinity in the range from 0 to 5%.

Of course, it is possible to use the rubber-like EPM and EPDM also in admixture with other polymers or rubbers, such as SBT, BR, CR, NBR, ABS, HNBR, polyethylene, polypropylene, polyethylene copolymers, LDPE, LLDPE, HMWPE, polysiloxanes, silicone rubbers and fluorinated rubbers. Corresponding mixtures are known to the person skilled in the art and can be optimised by means of a few tests.

Such rubber mixtures then generally contain from 5 to 300 parts by weight of an active or inactive filler, such as, for example,

highly disperse silicas prepared, for example, by precipitation of solutions of silicates or flame hydrolysis of silicon halides having specific surface areas of from 5 to 1000 m²/g, preferably from 20 to 400 m²/g (BET surface area), and having primary particle sizes of from 10 to 400 nm. The silicas may optionally also be in the form of mixed oxides with other metal oxides, such as Al, Mg, Ca, Ba, Zn, Zr, Ti oxides,

synthetic silicates, such as aluminium silicate, alkaline earth metal silicates, such as magnesium silicate or calcium silicate, having BET surface areas of from 20 to 400 m²/g and primary particle diameters of from 10 to 400 nm,

natural silicates, such as kaolin and other naturally occurring silicas,

glass fibres and glass-fibre products (mats, threads) or glass microspheres,

metal oxides, such as zinc oxide, calcium oxide, magnesium oxide, aluminium oxide,

metal carbonates, such as magnesium carbonate, calcium carbonate, zinc carbonate,

metal hydroxides, such as, for example, aluminium hydroxide, magnesium hydroxide,

carbon blacks. The carbon blacks to be used are prepared by the flame carbon black, furnace or gas carbon black process and have BET surface areas of from 20 to 200 m²/g, such as, for example, SAF, ISAF, HAF, FEF or GPF carbon blacks.

Special preference is given to silicas and carbon blacks.

The mentioned fillers may be used alone or in the form of a mixture.

The fillers are preferably added in the form of solids and mixed in in a known manner, for example by means of a kneader.

Further processing of the EPM and EPDM that can be prepared according to the invention mostly comprises a crosslinking step by means of peroxides, sulfur/sulfur donors or high-energy radiation. Such a step is known to the person skilled in the art, but express reference is made at this point to “Handbuch für die Gummi-Industrie”, published by Bayer A G, Leverkusen, 2nd edition, 1991, p. 231 ff. The EPM and EPDM may also be extended using oils, if desired.

The rubber mixtures according to the invention may contain further rubber auxiliary products, such as reaction accelerators, anti-ageing agents, heat stabilisers, light stabilisers, antioxidants, processing auxiliaries, plasticisers, tackifiers, blowing agents, colouring agents, pigments, waxes, extenders, organic acids, retarding agents, metal oxides as well as activators such as triethanolamine, polyethylene glycol, hexanetriol, etc., which are known in the rubber industry.

The rubber auxiliaries are used in conventional amounts, which are dependent inter alia on the intended use. Conventional amounts are, for example, amounts of from 0.1 to 50 wt. %, based on rubber.

Further mixing of the rubbers with the other mentioned rubber auxiliary products, crosslinking agents and accelerators may be carried out in the conventional manner with the aid of suitable mixing units, such as rolls, internal mixers and mixing extruders.

Compounding and vulcanisation are described in greater detail, for example, in Encyclopedia of Polymer Science and Engineering, Vol. 4, p. 66 ff (compounding) and Vol. 17, p. 666 ff (vulcanisation).

Vulcanisation of the rubber mixtures according to the invention may be carried out at conventional temperatures of from 100 to 200° C., preferably from 130 to 180° C. (optionally under a pressure of from 10 to 200 bar).

The rubber mixtures according to the invention are excellently suitable for the production of moulded bodies of any kind.

Non-limiting examples of such moulded bodies are O-rings, profiles, gaskets, membranes, coatings for other materials, damping elements and hoses.

### EXAMPLES

All operations up to working-up of the polymer were carried out under an inert gas atmosphere using Schlenk, injection and glove-box techniques. Argon from Linde having a degree of purity≧99.996% was used as the inert gas, which was after-purified by means of an Oxisorb cartridge from Messer-Griesheim. The toluene used for polymerisations and for preparing the catalyst and co-catalyst stock solutions was obtained from Riedel-de-Haën in a degree of purity≧99.5%. It was pre-dried for several days over potassium hydroxide, degassed, heated under reflux for at least one week over Na/K alloy and, finally, distilled for use.

(1-η⁵-Cyclopentadienyl-9-η⁵-fluorenyldiphenylsilyl)zirconium dichloride, [Ph₂Si(Cp)(Flu)]ZrCl₂, was obtained from Boulder Scientific. (1-η⁵-Cyclopentadi-dienyl-9-η⁵-fluorenyldimethylsilyl)zirconium dichloride, [Me₂Si(Cp)(Flu)]ZrCl₂, was prepared as specified in the literature, I. Beulich, dissertation, Hamburg University (1999). (1-η⁵-Cyclopentadienyl-9-η⁵-fluorenylisopropylidene)zirconium dichloride, [Me₂C(Cp)(Flu)]ZrCl₂, was likewise obtained as specified in the literature, H. Winkelbach, dissertation, Hamburg University (1997). 1.0·10⁻³ and 2.0·10⁻³ molar stock solutions in toluene were used for the polymerisation.

Methylaluminoxane from Witco was used as the co-catalyst. It was employed in the form of a solution in toluene having a concentration of 100 mg/ml.

The gaseous monomers ethene (Linde) and propene (Gerling, Holz & Co.) that are used have purities≧99.8%. Before being introduced into the reactor they were each passed through two purifying columns in order to eliminate traces of oxygen and sulfur. Both columns have a size of 3·300 cm³, an operating pressure of 8.5 bar, an operating temperature of 25° C. and ensure a volume flow rate of about 10 liters/minute. The first column in each case is packed with Cu catalyst (BASF R3-11) and the second column is packed with molecular sieve (10 Å).

The 5-ethylidene-2-norbornene was obtained from Aldrich as a mixture of the endo and exo forms having a purity≧99%, degassed, stirred for one week with n-tributyl-aluminium (Witco, 20 ml to 1 liter of ENB) and condensed off.

### Carrying Out the Polymerisation Reactions

The tightness of the apparatus was first checked, whereby both an applied vacuum and an assigned argon pressure of 4 bar had to remain constant for several minutes. Only then was thorough heating carried out at 95° C. under an oil-pump vacuum for one hour. The reactor was then brought to the reaction temperature of 30° C. and charged. The temperature was maintained with an accuracy of ±1° C. during the reaction.

For the terpolymerisations, 500 ml of toluene and 10 ml of MAO solution were placed in the reactor with an argon countercurrent, and then the required amount of the liquid monomer (ENB) was added. The solution was saturated first with propene and then with ethene. If saturation was reached, the polymerisation was started by injection of the metallocene solution. Ethene was metered in during the reaction so that the total pressure remained constant during the reaction but the monomer composition of the mixture changed constantly. The reactions were therefore stopped in the case of low conversions. The reaction was terminated by destroying the catalyst by injection of 5 ml of ethanol, and the gaseous monomers were carefully discharged into the hood.

Ethene and propene homopolymerisations were carried out in 200 ml of toluene with 4 ml of MAO solution at an ethene or propene pressure of 2 bar. The following table gives an overview of the composition of the reaction mixtures:

By way of example, without intending to limit the invention, [Me₂Si(Cp)(Flu)]ZrCl₂ (catalyst A) and [Ph₂Si(Cp)(Flu)]ZrCl₂ (catalyst B) were used. [Me₂C(Cp)(Flu)]ZrCl₂ (catalyst C) was used as the comparison system.

TABLE 1

| | | | | pₑₜₕₑₙₑ | pₚᵣₒₚₑₙₑ | V_{ENB} | Vₜₒₜₐₗ | c_{total monomer} |
|---|---|---|---|---|---|---|---|---|
| Example | Xₑₜₕₑₙₑ | Xₚᵣₒₚₑₙₑ | X_{ENB} | [bar] | [bar] | [ml] | [ml] | [mol/l] |
| 1 | 0.80 | 0.20 | — | 5.40 | 0.30 | — | 510 | 0.80 |
| 2 | 0.60 | 0.40 | — | 5.08 | 0.69 | — | 510 | 1.00 |
| 3 | 0.40 | 0.60 | — | 3.42 | 1.00 | — | 510 | 1.00 |
| 4 | 0.20 | 0.80 | — | 1.72 | 1.28 | — | 510 | 1.00 |
| 5 | 0.10 | 0.90 | — | 0.86 | 1.44 | — | 510 | 1.00 |
| 6 | 0.05 | 0.95 | — | 0.43 | 1.48 | — | 510 | 1.00 |
| 7 | 0.02 | 0.98 | — | 0.34 | 2.78 | — | 510 | 2.00 |
| 8 | 0.01 | 0.99 | — | 0.17 | 2.81 | — | 510 | 2.00 |
| 9 | 0.30 | 0.60 | 0.10 | 2.57 | 0.60 | 6.75 | 517 | 1.00 |
| 10 | | | | | | | | |
| 11 | | | | | | | | |

### Isolation of the Polymer

The polymer solutions in toluene were removed from the reactor and stirred overnight with 200 ml of aqueous 5% hydrochloric acid. The toluene phase was separated off, neutralised with 50 ml of saturated sodium hydrogen carbonate solution and washed three times using 100 ml of distilled water each time. After the toluene and the liquid monomer had largely been removed in a rotary evaporator at 30° C. and 40 mbar, the polymer was precipitated by addition of 100 ml of ethanol, isolated from the suspension and dried.

If that procedure failed because of the low molecular weight of the polymer, the residual toluene and monomer and the ethanol were removed in a rotary evaporator and the polymer was then dried. Drying was carried out overnight at 60° C. under an oil-pump vacuum.

### Polymer Analysis

Viscometry

An Ubbelohde viscometer (Oa capillary, K=0.005) adjusted to a temperature of 135° C. was used for the measurements. The solvent used was decahydronaphthalene (decalin), which was provided with 1 g/liter of 2,6-di-tert-butyl-4-methylphenol as stabiliser. The transit times were measured using a Viskoboy 2. For the preparation of the polymer solution, 50 ml of decahydronaphthalene were added to 50 mg of the polymer and the mixture was dissolved overnight at 135° C. in a closed flask, without stirring, and filtered while hot before the measurement. In order to clean the capillary, it was flushed twice with polymer solution. The measurements were repeated until constant values were obtained or a sufficient number of measured values to form a mean value was available. The molar masses for the EPMs and EPDMs were calculated using the Mark-Houwink constants for PE: k=4.75·10⁻⁴, a=0.725. In order to be able to compare the molar masses of the EPMs with values from the literature, the correction proposed by T. G. Scholte et al. in J. Appl. Polym. Sci 1984, 29, 3763 was carried out.

Differential scanning calorimetry (DSC)

DSC measurements to determine the melting temperature Tₘ, the enthalpy of fusion ΔHₘ and the glass transition temperature T_{g} were carried out using a DSC 821e from Mettler-Toledo. Calibration was carried out with indium (Tₘ=156.6° C.).

For the measurement, 10 mg of substance were weighed into small aluminium pans and measured at a rate of heating of 20° C./minute in the temperature range from −100° C. to 200° C. Of the data obtained by heating twice with intermediate cooling (−20° C./minute), the data from the second heating operation were used.

Microstructure

In order to determine the microstructure, the polymer is dissolved in a suitable solvent and poured in the form of a film onto infrared-inactive crystals, such as KBr. An infrared absorption spectrum of the resulting film is recorded, the individual molecular parts absorbing at specific wavenumbers; for incorporated ethene, for example, the bands at 720 cm⁻¹ and 1160 cm⁻¹ are evaluated. Those regions are integrated and converted into concentrations by calibration with a known material. The ethene and diene contents are thus obtained, and the difference with respect to 100% is taken to be the propene content.

The results obtained by way of example are summarised in Table 2 and are intended to illustrate the invention without intending to limit it to the Examples.

TABLE 2

| | | | | Activity | | | | | | Glass transition | | | Microstructure | | | | | |
|---|---|---|---|---|---|---|---|---|---|---|---|---|---|---|---|---|---|---|
| | Amount of substance | | | [t_{polymer}/molZr × | | | Molar mass M_{η} | | | temperature | | | [%] | | | | | |
| Ex- | in the mixture | | | h × molₘₒₙₒₘₑᵣ/l] | | | [g/mol] | | | [° C.] | | | Cat A | | Cat B | | Cat C | |
| ample | Xₑₜₕₑₙₑ | Xₚᵣₒₚₑₙₑ | X_{ENB} | Cat A | Cat B | Cat C | Cat A | Cat B | Cat C | Cat A | Cat B | Cat C | C₃ | ENB | C₃ | ENB | C₃ | ENB |
| 1 | 0.80 | 0.20 | 0 | 19.8 | 68.1 | 13.8 | n.c. | insol. | 77 100 | n.c. | n.c. | n.c. | 5 | 0 | 7 | 0 | 14 | 0 |
| 2 | 0.60 | 0.40 | 0 | 94.7 | 265.0 | 22.9 | 451 000 | insol. | 45 500 | n.c. | n.c. | n.c. | 11 | 0 | 14 | 0 | 27 | 0 |
| 3 | 0.40 | 0.60 | 0 | 80.6 | 158.0 | 17.4 | 331 000 | 302 000 | 31 600 | n.c. | −45 | n.c. | 21 | 0 | 25 | 0 | 40 | 0 |
| 4 | 0.20 | 0.80 | 0 | 82.2 | 96.7 | 18.1 | 176 000 | 177 000 | 24 400 | −50 | −55 | −52 | 35 | 0 | 41 | 0 | 60 | 0 |
| 5 | 0.10 | 0.90 | 0 | 34.2 | 20.5 | 16.9 | 140 000 | 156 000 | 25 800 | −56 | −53 | −39 | 50 | 0 | 57 | 0 | 75 | 0 |
| 6 | 0.05 | 0.95 | 0 | 9.3 | 7.6 | 13.0 | 117 000 | n.c. | 35 000 | −47 | −38 | −26 | 63 | 0 | 70 | 0 | 85 | 0 |
| 7 | 0.02 | 0.98 | 0 | 6.5 | 6.8 | 11.4 | 152 000 | 253 000 | 51 700 | −33 | −24 | −15 | 76 | 0 | 84 | 0 | 93 | 0 |
| 8 | 0.01 | 0.99 | 0 | 5.5 | 3.3 | 8.1 | 175 000 | 332 000 | 87 900 | −22 | −15 | −10 | 84 | 0 | 90 | 0 | 95 | 0 |
| 9 | 0.30 | 0.60 | 0.10 | 123.0 | 148.0 | 6.6 | 121 000 | 133 000 | 11 500 | −36 | −48 | −42 | 33 | 11 | 26 | 5 | 40 | 10 |
| 10 | | | | | | | | | | | | | | | | | | |
| 11 | | | | | | | | | | | | | | | | | | |

n.c. = not calculated

1. Process for the polymerisation of ethylene, α-olefin and, optionally, a non-conjugate diene using a metallocene as catalyst, characterised in that the metallocene used is a compound of the general formula (I) 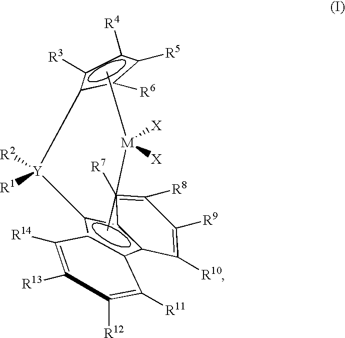
wherein
R¹ to R¹⁴ are each independently of the others H, C₁-C₁₂-alkyl radicals, C₆-C₁₂-aryl radicals or C₇-C₁₂-aralkyl radicals,
X represents H, halogen, C₁-C₁₂-alkyl radicals,
Y represents Si and Ge,
M represents a metal of group 4 of the periodic system of the elements according to IUPAC 1985,
optionally in the presence of one or more co-catalysts.

2. Process according to claim 1, characterised in that the α-olefin is selected from the group consisting of propylene, 1-butene, 1-hexene and 1-octene.

3. Process according to claim 1, characterised in that an alumoxane is used as co-catalyst.

4. Process according to claim 1, characterised in that a non-coordinating anion is used as co-catalyst.

5. Process according to claim 1, characterised in that an alumoxane or aluminium alkyl is used as co-catalyst.

6. Process according to claim 1, characterised in that the polymerisation is carried out in the presence of inert organic solvents.

7. Process according to claim 1, characterised in that the catalyst or catalyst system is applied to an inorganic support.

8. Process according to claim 1, characterised in that the non-conjugate diene is selected from the group consisting of 5-ethylidene-2-norbornene (ENB), 5-vinylnorbornene, 1,4-hexadiene and dicyclopentadiene.

9. Process according to claim 1, characterised in that the metallocene used is a compound of formula (II) 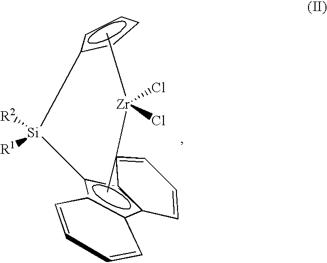
wherein
R¹ and R² are each independently of the other methyl, ethyl, n-propyl, isopropyl, tert-butyl, phenyl or cyclohexyl.
